(19) United States
(12) Patent Application Publication
(10) Pub. No.: US 2004/0066292 A1
(43) Pub. Date: Apr. 8, 2004

(54) Alarm system

(76) Inventor: Masashi Iwasawa, Ohtsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/246,522

(22) Filed: Sep. 19, 2002

(51) Int. Cl. G08B 1/08

(52) U.S. Cl. 340/539.1

(57) ABSTRACT

A transmitter 1 comprises a signaling history information transmission unit 15. After the transmitter 1 generates a detection signal, the signaling history information transmission unit 15 sends corresponding signaling history information to a regular signal transmission unit 13. From this regular signal transmission unit 13, the signaling history information and the regular signal are transmitted to the receiver 2. The signaling history information contains a count value which is updated at every transmission of the information. Even if the transmitter 1 generates a detection signal during communication failure, the receiver 2 can identify the time when the transmitter 1 generated the detection signal, based on the received count value.

### BACKGROUND OF THE INVENTION

The present invention relates to an alarm system which produces an alarm signal when it detects an intruder into an office, factory, etc. (e.g. the alarm system reports such event to a security company) In particular, the present invention relates to a measure for ensuring transmission of such an alarm signal, even if an intruder is detected during communication failure or the like.

Regarding the alarm system which produces an alarm signal on detecting an intruder into an office, factory, etc., a conventional system is equipped with a transmitter which generates a detection signal on detection of an intruder in its monitoring area, and a receiver which reports to a security company (i.e. produces an alarm signal) on receiving the detection signal from the transmitter.

The transmitter is a passive infrared sensor or an active infrared sensor (infrared beam interruption sensor). The passive infrared sensor detects far-infrared rays emitted from a person who enters its monitoring area, and produces a detection signal when the amount of detected rays exceeds a predetermined threshold level. For another, the active infrared sensor is provided with an emitter containing an emitting element and a receiver containing a receiving element. With the emitter and the receiver being disposed face to face across a monitoring area, the emitter projects a near-infrared beam toward the receiver. If the near-infrared beam directed from the emitter to the receiver is interrupted by an intruder and thus the amount of beam received by the receiving element changes, the sensor produces a detection signal.

There is a different type of alarm system which utilizes the polling system. As illustrated in FIG. 3, a plurality of active infrared sensors 4, 4, 4 are provided such that a detection signal can be transmitted between the respective infrared sensors 4, 4. According to the polling system, when any of the infrared sensors 4 detects a person and produces a detection signal, the signal is successively transmitted to the infrared sensor(s) 4 located downstream along the direction of transmission. Finally, from the infrared sensor 4 which locates at the downstream end along the transmission direction, the detection signal is sent to a receiver 2.

Concerning the above-mentioned alarm systems, however, if the transmission circuit of the transmitter fails or if it is adversely affected by a noise while transmitting a detection signal, the detection signal may not be received by the receiver. Besides, in the case of the polling system, the transmission line of the detection signal is interrupted, if communication failure occurs temporarily in one of the active infrared sensors, or if any of the active infrared sensors is temporarily suspended in an artificial manner. As far as the transmission line remains interrupted, any detection signal produced by a sensor which locates upstream of the interrupted position in the transmission line fails to reach the receiver.

In this situation, by the time when the normal communication state is recovered between the transmitter and the receiver, it is often the case that the transmitter has finished transmission of a detection signal. Under such circumstances, the receiver never recognizes the fact that the transmitter detected an intruder. To summarize, if a person enters the monitoring area during communication failure, etc., the alarm system cannot recognize the intruder and cannot ensure a reliable operation.

The present invention is made in view of such drawbacks. With regard to an alarm system composed of a transmitter and a receiver and producing an alarm signal when the receiver receives a detection signal from the transmitter, the present invention intends to provide an alarm system in which an alarm signal can be produced with certainty even in the event of communication failure between the transmitter and the receiver.

### SUMMARY OF THE INVENTION

To achieve the above object, an alarm system of the present invention is based on an alarm system having a transmission means which generates a detection signal on detection of an object in a monitoring area, and a receiving means which generates an alarm signal on receiving the detection signal from the transmission means. In the alarm system of the present invention, the transmission means is provided with a means for transmitting signaling history information. After the transmission means generates a detection signal on detection of an object, this signaling history information transmission means produces, at a predetermined time interval, signaling history information which relates to when the detection signal is generated, and allows the signaling history information to be received by the receiving means.

In the event of communication failure, etc., if the transmission means generates a detection signal on detection of an object, the receiving means may not be able to recognize the detection signal. Even in this situation, the above alarm system arranges the signaling history information transmission means to produce, at a predetermined time interval, signaling history information which relates to the time when the detection signal is generated. Therefore, after the failure is recovered, the receiving means can receive the signaling history information, based on which the receiving means can recognize a previous signaling operation and produce an alarm signal. Namely, the receiving means never misses any signaling operation during the communication failure, thereby producing an alarm signal without fail. The resulting alarm system exhibits a remarkable reliability.

In a preferable arrangement, the signaling history information relates to when the detection signal is generated or how many times the signaling history information is transmitted. As a result, the receiving means can, easily and accurately, identify the time when the transmission means previously generated a detection signal. In addition, this arrangement enables the receiving means to compare the time when an alarm signal is produced, with the signaling history information received by the receiving means. Thereby, the receiving means can determine whether it has produced an alarm signal in response to particular signaling history information.

The transmission means may comprise a means for transmitting a regular signal to the receiving means at a predetermined time interval. Besides, the regular signal transmission means may be arranged to receive the signaling history information from the signaling history information transmission means, and to send the signaling history information and the regular signal to the receiving means. Owing to this arrangement, the signaling history information can be sent to the receiving means, with the use of the regular signal transmission means which is conventionally included in the transmission means of an alarm system. Namely, this regular signal transmission means serves not only as the source for transmitting the regular signal but also as the source for transmitting the signaling history information. Hence, the resulting transmission means can achieve the above operations, without complicating its structure.

In such an arrangement, the regular signal transmission means may be arranged to send the regular signal at a shorter interval, if the signaling history information transmission means starts transmission of the signaling history information. According to this arrangement, the signaling history information can be sent to the receiving means also at a shorter interval, so that the receiving means can receive the signaling history information substantially at the same time with the recovery of the normal communication state. Consequently, the receiving means can quickly recognize a previous signaling operation by the transmission means.

With respect to the above arrangements, the signaling history information transmission means may be arranged to end transmission of the signaling history information, after it sends the signaling history information for a predetermined period of time or a predetermined number of times. This arrangement prevents transmission of the signaling history information which is likely to have been received by the receiving means. Namely, this arrangement avoids transmission of unnecessary signaling history information, and reduces the amount of signaling history information data to be transmitted from the transmission means.

Further regarding the above arrangements, the signaling history information transmission means may be arranged to supply the receiving means with signaling history information which relates to all detection signals previously generated by the transmission means. According to this arrangement, the signaling history information can be sent to the receiving means without omission, thus allowing the receiving means to recognize the whole signaling history in the transmission means.

Alternatively, the signaling history information transmission means may be arranged to supply the receiving means with signaling history information which relates to the oldest detection signal among the detection signals previously generated by the transmission means. In the case where a plurality of detection signals have been generated by the transmission means, this arrangement allows the receiving means to identify the time when the oldest (hence considered significant) signal was generated. Accordingly, it is possible to acquire effective information, with the minimum amount of data transmission from the transmission means.

### BRIEF DESCRIPTION OF THE DRAWINGS

FIG. 1 schematically shows a configuration of the alarm system concerning the first embodiment.

FIG. 2 is a block diagram of the circuitry of the transmitter.

FIG. 3 schematically shows a configuration of the alarm system concerning the second embodiment.

FIG. 4 schematically shows a configuration of the alarm system concerning a modification of the second embodiment.

### DESCRIPTION OF THE PREFERRED EMBODIMENTS

Embodiments of the present invention are hereinafter described with reference to the drawings. In the following embodiments, the present invention is applied to a security system or the like which is installed for nighttime security in an office, factory, etc. and which serves to detect an intruder who enters its monitoring area.

(First Embodiment)

The first embodiment is arranged to detect an intruder into a monitoring area, with the use of an active infrared sensor.

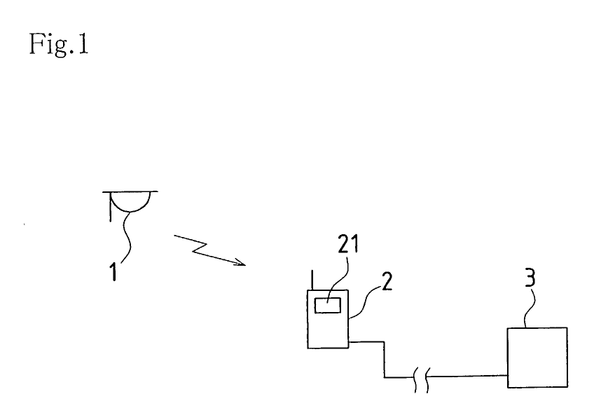

FIG. 1 schematically shows a configuration of the alarm system concerning this embodiment. As illustrated, this alarm system is composed of a transmitter 1 (as a transmission means) which is constituted with a passive infrared sensor unit and a radio transmission unit, and a receiver 2 (as a receiving means) which receives a radio detection signal from the transmitter 1. It is a simplex communication system in which signals can flow only from the transmitter 1 to the receiver 2. The receiver 2 is connected, for example, with a management server 3 at a security company. When a detection signal is sent from the transmitter 1, the receiver 2 reports detection of a person (i.e. sends an alarm signal) to the management server 3.

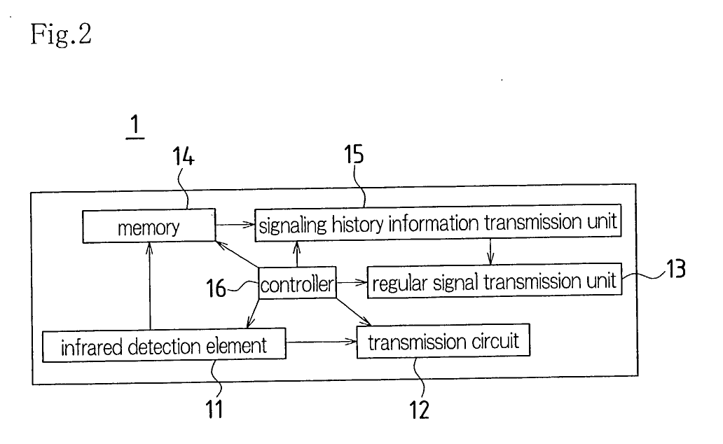

FIG. 2 is a block diagram showing the circuitry of the transmitter 1. As illustrated, the transmitter 1 includes an infrared detection element 11, a transmission circuit 12, a regular signal transmission unit 13, a memory 14, a signaling history information transmission unit 15 and a controller 16.

The infrared detection element 11 is made, for example, of a pyroelectric element. In a predetermined monitoring area, the infrared detection element 11 detects an infrared ray emitted from a person or the like, and produces a signal when the amount of received infrared ray exceeds a predetermined threshold level. In response to the signal generated by the infrared detection element 11, the transmission circuit 12 sends a detection signal to the receiver 2.

The regular signal transmission unit 13 sends a regular signal (a supervised signal) to the receiver 2 at a certain time interval. Normal operation of the alarm system is confirmed by constant receipt of regular signals by the receiver 2. Namely, the state where the receiver 2 does not receive the regular signal can be determined as system failure (failure of the transmitter 1 or the receiver 2, or communication failure). In this case, the receiver 2 sends a failure signal to the management server 3.

When the infrared detection element 11 generates a signal, the memory 14 acquires and stores signaling information about the signaling operation by the infrared detection element 11. This storage operation is carried out every time the infrared detection element 11 generates a signal. Accordingly, the memory 14 accumulates the information about the history of previous signaling operations by the infrared detection element 11.

As mentioned above, a detection signal is sent from the transmission circuit 12 to the receiver 2, in response to the signaling operation by the infrared detection element 11. Thereafter, the signaling history information transmission unit 15 transmits, at a certain time interval, signaling history information which relates to the time when this detection signal is generated. To be specific, the unit 15 reads the information stored in the memory 14 and sends the signaling history information to the regular signal transmission unit 13 at a constant time interval. In other words, if the memory 14 stores information about a previous signaling operation by the infrared detection element 11, the unit 15 sends the information to the regular signal transmission unit 13 at a constant time interval.

Besides, the signaling history information transmission unit 15 has a built-in counter. Every time the signaling history information transmission unit 15 sends signaling history information to the regular signal transmission unit 13, the unit 15 updates the count value (i.e. information as to how many times the signaling history information has been sent) which is added to the signaling history information. Thereby, the signaling history information sent to the regular signal transmission unit 13 contains a count value which is updated at every transmission of the information. This signaling history information is then transmitted to the receiver 2, together with a regular signal from the regular signal transmission unit 13.

In addition, when the count value reaches “100”, the signaling history information transmission unit 15 ends transmission of the signaling history information. To give an example, after the infrared detection element 11 generates a signal (the first signaling operation), a series of relevant signaling history information which contains an increasing count value is sent to the receiver 2 at a certain time interval. In this situation, it is supposed that the infrared detection element 11 produces another signal (the second signaling operation) when the transmission count of the signaling history information is “50”. Then, the signaling history information transmission unit 15 simultaneously sends signaling history information with the count “51” (which relates to the first signaling operation by the infrared detection element 11) and signaling history information with the count “1” (which relates to the second signaling operation by the infrared detection element 11). Later, when the count value of the former signaling history information reaches “100”, the unit 15 ends transmission of the former signaling history information, and continues to transmit only the latter signaling history information. By the way, when the transmission of the former signaling history information ends at the count “100”, the latter signaling history information carries the count “50”. Of course, the count value for discontinuing the transmission of the signaling history information need not necessarily be “100”, but may be optionally set to any value.

The CPU 16 is in charge of comprehensive management and control over the constituents 11-15 of the transmitter 1.

Now, regarding the receiver 2, it includes a receiver unit (not shown) for receiving the signaling history information. When this receiver unit recognizes the signaling history information, the receiver 2 can recognize a previous signaling operation by the infrared detection element 11, and identify how many signals were generated and when each such signal was generated. For example, while the regular signal transmission unit 13 is set to produce a regular signal at every minute, the infrared detection element 11 is assumed to have generated two signals in the manner mentioned above. In this case, on receiving signaling history information with the count “51” and signaling history information with the count “1”, the receiver 2 recognizes that the infrared detection element 11 generated a signal (i.e. detected an intruder) twice, 51 minutes ago and 1 minute ago, respectively.

Incidentally, when the receiver 2 receives a detection signal from the transmitter 1, the receiver 2 reports to the management server 3 through a communication line (e.g. a public circuit). In addition, on receiving the signaling history information, the receiver 2 may inform the management server 3 of the count value. Accordingly, the security company can recognize a previous signaling operation by the infrared detection element 11, and identify how many signals were generated and when each such signal was generated.

The receiver 2 is also equipped with a LCD (Liquid Crystal Display) panel 21 for indicating receipt of a detection signal and signaling history information sent from the transmitter 1. As such display means, an LED (Light Emitting Diode) display may be used as well.

The operation of the alarm system of this constitution is described below. The operational feature of this system is observed when a person or the like enters the monitoring area during communication failure between the transmitter 1 and the receiver 2. Therefore, the following description is focused on the operation under such circumstances.

If the transmission circuit 12 in the transmitter 1 fails, or if it is adversely affected by a noise while transmitting a detection signal, the detection signal is not received by the receiver 2.

Even in this situation, the signaling history information transmission unit 15 supplies the regular signal transmission unit 13 with a series of signaling history information containing an increasing count value which is updated at every transmission of the information. The regular signal transmission unit 13 receives the signaling history information, and sends it to the receiver 2 in synchronization with the transmission timing of the regular signal. The unit 15 continues the transmission of the signaling history information until the count value reaches “100”, that is, until the information is transmitted 100 times.

After the communication between the transmitter 1 and the receiver 2 is resumed, the receiver 2 receives the signaling history information as well as the regular signal. Based on this information, the receiver 2 recognizes a previous signaling operation by the infrared detection element 11, and identifies how many signals were generated and when each such signal was generated. Then, through a communication line, the receiver 2 informs the management server 3 of detection of an intruder and the count value. As a result, the security company can recognize a previous signaling operation by the infrared detection element 11, and identify how many signals were generated and when each such signal was generated.

Thus, according to the alarm system of this embodiment, even in the case where the transmitter 1 generates a detection signal on detection of an intruder but the receiver 2 cannot receive the signal due to communication failure or some other reason, a series of the signaling history information is produced at a certain time interval and received later by the transmitter 2. Therefore, the receiver 2 can recognize, without omission, the signaling operation during communication failure.

Moreover, in order to send the signaling history information to the receiver 2, this alarm system makes effective use of the regular signal transmission unit 13, which is conventionally included in the transmission means of an alarm system. Hence, it is possible to send the signaling history information to the receiver 2, without complicating the structure of the transmitter 1.

(Second Embodiment)

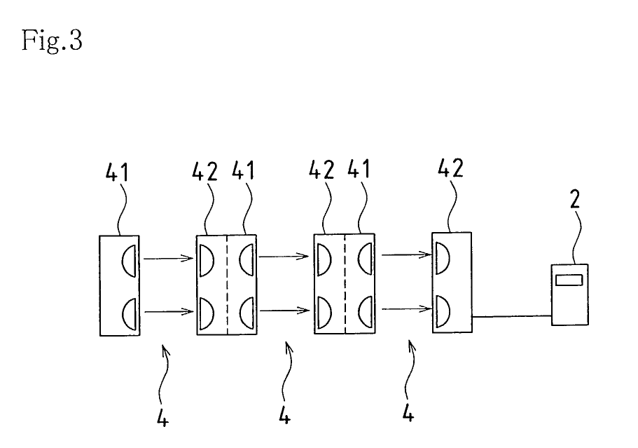

Now, the second embodiment of the invention is described. In the second embodiment, the present invention is applied to an alarm system called polling system. FIG. 3 schematically shows a configuration of this alarm system. As illustrated, this alarm system includes a plurality of active infrared sensors 4, 4, 4. To be specific, the active infrared sensors 4 are disposed to cover the respective monitoring areas, with an emitter 41 and a receiver 42 of each sensor facing one another across its monitoring area. Regarding the adjacent sensors 4, 4, the receiver 42 of one of the sensors and the emitter 41 of the other sensor are of integrated structure and connected such that a detection signal can be transmitted from the receiver 42 to the emitter 41. Each emitter 41, which emits an infrared pulse signal to a corresponding receiver 42, is arranged to be capable of adding a detection signal and signaling history information to the infrared pulse signal. Thus, when any of the infrared sensors 4 detects an intruder and generates a signal, the detection signal is successively transmitted to the infrared sensor(s) 4 located downstream along the direction of transmission (the right sensor(s) in the figure). Finally, from the infrared sensor 4 which locates at the downstream end of the transmission, the detection signal is sent to the receiver 2. In other words, the detection signal is transmitted downstream, along with a pulse signal of the near-infrared beam which is produced by each emitter 41.

The circuitry of the receiver 42 of each infrared sensor 4 includes the transmission circuit 12, the regular signal transmission unit 13, the memory 14, the signaling history information transmission unit 15 and the controller 16, which are similar to those found in the transmitter 1 of the first embodiment. As the functions of these constituents are already mentioned in the first embodiment, detailed description is not repeated herein. In this embodiment, the infrared sensors 4, 4, 4 constitute the transmission means as called in this invention.

The alarm system of the second embodiment operates in the following manner. When any of the infrared sensors 4 detects an intruder and generates a signal, the detection signal is successively transmitted to the infrared sensor(s) 4 located downstream along the transmission direction. However, if communication failure occurs temporarily at one of the active infrared sensors 4, 4, 4, or if any of the active infrared sensors 4 is temporarily suspended in an artificial manner, the transmission line of the detection signal is interrupted and thus the detection signal cannot be received by the receiver.

Even in this situation, the signaling history information transmission unit 15 produces a series of signaling history information containing an increasing count value which is updated at every transmission of the information, as is the case in the first embodiment. After the normal communication state is recovered, the signaling history information is successively transmitted to the infrared sensor(s) 4 located downstream along the transmission direction. Finally, in the infrared sensor 4 which locates at the downstream end of the transmission, the regular signal transmission unit 13 sends the signaling history information to the receiver 2 in synchronization with the transmission timing of a regular signal. Based on the signaling history information, the receiver 2 recognizes that any of the infrared sensors detected an intruder and generated a signal, and identifies how many signals were generated and when each such signal was generated. Then, through the communication line, the receiver 2 informs the management server 3 of detection of an intruder and the count value. As a result, the security company can recognize a signaling operation by any of the infrared sensors 4, and identify how many signals were generated and when each such signal was generated.

(Other Embodiments)

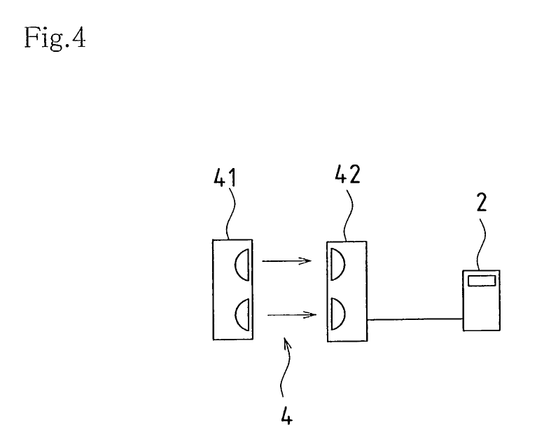

In the above-mentioned second embodiment, the present invention is applied to a polling system in which a plurality of active infrared sensors are arranged in a communicable relationship. However, the present invention should not be limited to this arrangement. As illustrated in FIG. 4 which concerns a modification of the second embodiment, the invention is also applicable to an alarm system utilizing a single active infrared sensor 4. In this modified embodiment, the receiver 42 has the same structure as the receiver of the infrared sensor which locates at the downstream end of the transmission, as adopted in the polling system of the second embodiment.

The polling system concerning the second embodiment is constituted with a combination of three active infrared sensors 4, 4, 4. However, the present invention should not be limited to this arrangement, and is still applicable where two or more than three active infrared sensors are used in combination.

In the first embodiment, the transmitter 1 and the receiver 2 are communicated by radio. Additionally, the present invention is applicable if they are communicated by wire. Likewise, regarding the second embodiment, communication between the infrared sensors 4, 4 may be established by radio.

As a manner of identifying the time when a detection signal is generated, the above embodiments utilize a count value which is added to the signaling history information. Instead, a timer may be provided to the transmitter 1 or each of the infrared sensors 4, so that the signaling history information to be sent to the receiver 2 can contain information about the time of a signaling operation.

As another arrangement, if the signaling history information transmission unit 15 starts transmission of signaling history information, the regular signal may be sent at a shorter interval. According to this arrangement, the signaling history information can be sent to the receiver 2 also at a shorter interval, so that the receiver 2 can receive the signaling history information substantially at the same time with the recovery of the normal communication state. Consequently, the receiver 2 can quickly recognize a previous signaling operation by the transmitter 1 or any of the infrared sensors 4.

As for the mode of transmitting the signaling history information, it is not always necessary to synchronize the transmission of the signaling history information with that of the regular signal. Instead, the signaling history information may be sent by a separate source for transmitting the signaling history information, at a different timing from the transmission timing of the regular signal.

As a manner of ending the transmission of the signaling history information, the above embodiments decides to terminate such transmission, depending on whether the count value reaches the predetermined value (100 in the above embodiments) or not. Instead, transmission of the signaling history information may be discontinued at the moment when the total transmission time of the signaling history information amounts to a predetermined period of time.

In still another alternative, the signaling history information to be sent to the receiver 2 may relate to all detection signals previously generated in the transmitter 1. In this case, the signaling history information can be sent to the receiver 2 without omission, thus allowing the receiver 2 to recognize the whole signaling history in the transmitter 1.

In yet another alternative, the signaling history information to be sent to the receiver 2 may relate only to the oldest detection signal among the detection signals previously generated by the transmitter 1. In the case where a plurality of detection signals have been generated by the transmitter 1, this arrangement allows the receiver 2 to identify the time when the oldest (hence considered significant) signal was generated. Accordingly, it is possible to acquire effective information, with the minimum amount of data transmission from the transmitter 1.

What is claimed is:

1. An alarm system having a transmission means which generates a detection signal on detection of an object in a monitoring area, and a receiving means which generates an alarm signal on receiving the detection signal from the transmission means,
characterized in that the transmission means comprises a means for transmitting signaling history information, wherein, after the transmission means generates a detection signal on detection of an object, the signaling history information transmission means produces, at a predetermined time interval, signaling history information which relates to when the detection signal is generated, and allows the signaling history information to be received by the receiving means.

2. An alarm system according to claim 1,
wherein the signaling history information relates to when the detection signal is generated or how many times the signaling history information is transmitted.

3. An alarm system according to claim 1 or 2,
wherein the transmission means comprises a means for transmitting a regular signal to the receiving means at a predetermined time interval,
the regular signal transmission means being arranged to receive the signaling history information from the signaling history information transmission means, and to send the signaling history information and the regular signal to the receiving means.

4. An alarm system according to claim 3,
wherein the regular signal transmission means is arranged to send the regular signal at a shorter interval, if the signaling history information transmission means starts transmission of the signaling history information.

5. An alarm system according to any of claims 1 to 4,
wherein the signaling history information transmission means is arranged to end transmission of the signaling history information, after it sends the signaling history information for a predetermined period of time or a predetermined number of times.

6. An alarm system according to any of claims 1 to 4,
wherein the signaling history information transmission means is arranged to supply the receiving means with signaling history information which relates to all detection signals previously generated by the transmission means.

7. An alarm system according to claim 5,
wherein the signaling history information transmission means is arranged to supply the receiving means with signaling history information which relates to all detection signals previously generated by the transmission means.

8. An alarm system according to any of claims 1 to 4,
wherein the signaling history information transmission means is arranged to supply the receiving means with signaling history information which relates to the oldest detection signal among the detection signals previously generated by the transmission means.

9. An alarm system according to claim 5,
wherein the signaling history information transmission means is arranged to supply the receiving means with signaling history information which relates to the oldest detection signal among the detection signals previously generated by the transmission means.
